(19) United States
(12) Patent Application Publication
(10) Pub. No.: US 2021/0383451 A1
(43) Pub. Date: Dec. 9, 2021

(54) ITERATIVE, MULTI-USER SELECTION AND WEIGHTING RECOMMENDATION ENGINE

(71) Applicant: Ask Sydney, LLC, Dix Hills, NY (US)

(72) Inventors: Sydney Nicole Epstein, Dix Hills, NY (US); Paul Lawrence Epstein, Dix Hills, NY (US); Richard Allen Vaughn, Arlington, TX (US); Bryan Mark Yearwood, Prosper, TX (US)

(21) Appl. No.: 17/284,909

(22) PCT Filed: Oct. 15, 2019
(86) PCT No.: PCT/US2019/056374

§ 371 Date: Apr. 13, 2021

Related U.S. Application Data
(60) Provisional application No. 62/745,794, filed on Oct. 15, 2018.

(51) Int. Cl. G06Q 30/06

(52) U.S. Cl. CPC G06Q 30/0631

(57) ABSTRACT

One or more systems and computer-implemented methods are disclosed that provide recommendations that account for preferences of each user within a group of users, that leverage communities of users with similar interests when providing a recommendation for a user or a group of users, that allow for a user or a group of users to identify the attributes of a specific input as the basis for the input, and/or let a user or a group of users identify attributes as a starting point, or that must be included within recommended images or items, during one or more sessions for providing recommendations.

### CROSS-REFERENCE TO RELATED APPLICATION(S)

This application claims priority to and benefit of U.S. Provisional Patent Application Ser. No. 62/745,794, filed on Oct. 15, 2018, which is hereby incorporated by reference herein in its entirety.

### FIELD OF THE PRESENT DISCLOSURE

Aspects of the present disclosure relate generally to systems and methods for providing recommendations to a user or a group of users.

### BACKGROUND

Recommendation systems generally do not account for a group of users who are looking for a recommendation as a group. Recommendation systems also generally do not accurately leverage the preferences of communities of users with similar interests in providing recommendations for a user or a group of users. Recommendation systems also generally do not allow for a user or a group of users to identify one or more attributes of a specific input as the basis for the input. Recommendation systems also generally do not let a user or a group of users identify attributes as a starting point, or the attributes that must be included within recommended images or items, during a session for providing a recommendation.

According to aspects of the present disclosure, systems and computer-implemented methods are disclosed that solve the above and related problems.

### SUMMARY

An aspect of the present disclosure includes a computer-implemented method for providing a recommendation for a group. The method includes receiving, by one or more computer devices, an indication, from a plurality of electronic devices associated with a plurality of users, of an instance of an application executed on each electronic device of the plurality of electronic devices; the plurality of indications identifying the plurality of electronic devices as belonging to the group. The method further includes transmitting, from the one or more computer devices, one image, from among a plurality of images, to the plurality of electronic devices, the one image being associated with one or more sets of tags from among a plurality of tags, each tag of the one or more sets of tags describing or characterizing attributes of the one image. The method further includes receiving, by the one or more computer devices, and from the plurality of electronic devices, an input from each electronic device of the plurality of electronic devices indicating a preference for the one image for each user of the plurality of users. The method further includes determining, by the one or more computer devices, a group preference based on the plurality of preferences for the one image. The method further includes weighting, by the one or more computer devices, each tag of the one or more sets of tags based, at least in part, on the group preference. The method further includes processing, by the one or more computer devices, the plurality of tags based, at least in part, on the weighted tags of the one or more sets of tags, the group preference, or a combination thereof to determine a next image from the plurality of images associated with the weighted tags; the next image being different from the one image. The method further includes generating a sequence of images by repeating the transmitting, the receiving, the determining, the weighting, and the processing with the next image in place of the one image and the weighted tags in place of the one or more sets of tags during a session for providing the recommendation for the group.

Another aspect of the present disclosure includes a computer-implemented method of collaborative filtering. The method includes receiving, by one or more computer devices, an input by a user, via a user interface of an electronic device, indicating a preference for a first item represented by a first image presented on a display of the electronic device; the first image being associated with a first set of tags. The method further includes determining, by the one or more computer devices, a second set of tags based, at least in part, on the first item, the first set of tags, or a combination thereof. The method further includes determining, by the one or more computer devices, a set of second images associated with the second set of tags. The method further includes determining, by the one or more computer devices, a weighted relationship between the first image and each second image of the second set of images, the weighted relationship being based on preferences of a plurality of users for the first image and each second image of the second set of images. The method further includes selecting, by the one or more computer devices, one second image from the set of second images as a recommended image based on the weighted relationship between the first image and the one second image relative to the weighted relationships between the first image and each remaining second image of the set of second images.

A further aspect of the present disclosure includes a computer-implemented method for providing a basis for a preference of a user. The method includes transmitting, from one or more computer devices, one image, from among a plurality of images, to an electronic device, the one image being associated with one or more sets of tags from a plurality of tags, each tag of the one or more sets of tags indicating attributes of the one image. The method includes receiving, from the electronic device, at least one input indicating a preference of the user for the one image and a basis of the preference of the user. The method includes processing, by the one or more computer devices, the plurality of tags based on the basis of the preference to determine a next set of tags from the plurality of tags. The method includes determining, by the one or more computer devices, a next image from the plurality of images associated with the next set of tags, the next set of tags indicating attributes of the next image. The method further includes generating a sequence of images by repeating the transmitting, the receiving of the at least one input, the processing, and the determining with the next image in place of the one image during a session of presenting an interest of the user.

Another aspect of the present disclosure includes a computer-implemented method for providing a recommendation for a group of users. The method includes receiving, by one or more computer devices, a selection of one or more tags, from among a plurality of tags, from at least one electronic device, from among a plurality of electronic devices associated with the group of users. The method includes transmitting, from the one or more computer devices, one image, from among a plurality of images, to the plurality of electronic devices, the one image being associated with a set of first tags from among a plurality of tags, each tag of the set of first tags describing or characterizing attributes of the one image, and at least one tag from the one or more tags being included within the set of first tags. The method includes receiving, by the one or more computer devices, and from the plurality of electronic devices, an input from each electronic device of the plurality of electronic devices indicating a preference for the one image for each user of the plurality of users. The method includes processing, by the one or more computer devices, the plurality of tags based, at least in part, on the plurality of preferences and the one or more tags to determine a next image from the plurality of images, the next image being different from the one image and including at least one tag from the one or more tags. The method includes generating a sequence of images by repeating the transmitting, the receiving, and the processing with the next image in place of the one image and the next set of tags in place of the one or more sets of tags during a session for providing the recommendation for the group.

Additional aspects of the present disclosure include one or more computer-readable, non-transitory, storage media encoding machine-readable instructions that, when executed by one or more computers, cause operations to be carried out, the operations including the above method steps, or combinations thereof.

Additional aspects of the present disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a functional block diagram of a computer system according to aspects of the present disclosure.

FIG. 2 is a flowchart of a computer-implemented method or algorithm for providing a recommendation for a group according to aspects of the present disclosure.

FIG. 3A illustrates the weighting of tags for providing a recommendation for a group according to aspects of the present disclosure.

FIG. 3B illustrates another weighting of tags for providing a recommendation for a group according to aspects of the present disclosure.

FIG. 4A is a flowchart of a computer-implemented method or algorithm of collaborative filtering according to aspects of the present disclosure.

FIGS. 4B-4D are diagrams illustrating the computer-implemented method or algorithm of FIG. 4A for collaborative filtering according to aspects of the present disclosure.

FIG. 5A is a flowchart of a computer-implemented method or algorithm for providing a basis for a preference of a user according to aspects of the present disclosure.

FIG. 5B illustrates a user interface of a computer-implemented method or process of visualizing tags for providing a basis for a preference of a user according to aspects of the present disclosure.

FIG. 6 is a flowchart of a computer-implemented method or algorithm for providing a recommendation for a group of users according to aspects of the present disclosure.

### DETAILED DESCRIPTION

While this disclosure is susceptible of embodiment in many different forms, there is shown in the drawings and will herein be described in detail example implementations of the inventions and concepts herein with the understanding that the present disclosure is to be considered as an exemplification of the principles of the inventions and concepts and is not intended to limit the broad aspect of the disclosed implementations to the examples illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

A (software) module can refer to computer-readable item code that executes a software sub-routine or program, which corresponds to instructions executed by any microprocessor or microprocessing device to perform described functions, acts, or steps. Any of the methods or algorithms or functions described herein can include non-transitory machine or computer-readable instructions for execution by: (a) an electronic processor, (b) an electronic controller, and/or (c) any other suitable electronic processing device. Any algorithm, software module, software component, software program, routine, sub-routine, or software application, or method disclosed herein can be embodied as a computer program product having one or more non-transitory tangible medium or media, such as, for example, a flash memory, a CD-ROM, a floppy disk, a hard drive, a digital versatile disk (DVD), or other electronic memory devices, but persons of ordinary skill in the art will readily appreciate that the entire algorithm and/or parts thereof could alternatively be executed by a device other than an electronic controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.).

### Multiple User Quiz

Aspects of the present disclosure include methods and systems related to using responses by multiple users in a single session to determine an item that the group is interested in. In one or more embodiments, tags associated with images presented to the users of the group are weighted according to preference of the group. In one or more embodiments, each member of the group can user their own electronic device to view and provide their preferences to one or more images presented on the electronic device. The weighting allows the methods and systems to iteratively guide the group of users to an item that the group may prefer. Thus, the methods and systems use iterative responses by each member of the group to determine an item that the group, such as the majority of the group, or the group as a whole, may be interested in.

### Collaborative Filtering and Iterative Searching

Aspects of the present disclosure include methods and systems related to using responses of a community of users to images, and tags associated with the images, to aid in guiding a user, or a group of users, to an item that the user or group of users may prefer. Images can be presented to the user or the group of users in an iterative session, and responses to those images can be associated with the tags associated with the images. Responses by other users to the same images can be used to (1) weight the tags, (2) determine a next image to present, or both for the user or the group of users, or both.

In one or more embodiments, a community can be defined and the responses of the community can be used to guide the user or a group of users to an interest. The community can be based on, for example, the age, gender, demography, geography, etc. associated with the user and the members (e.g., other users) of the community. Images or tags that the community and the user share in common can be weighted higher than images or tags that the community and the user do not share in common. Alternatively, the images or tags can be weighted according to a percentage of the community that shares the same preferences as the user. The weighting then affects the outcome of the user's or group of users' search session. Such a collaborative recommendation within a community of users increases the efficiency and the accuracy by utilizing the known responses of the community to a given tag/combination of tags, and incorporating those known responses into the present logic that provides weighting to a given tag/combination of tags.

### Multiple Tags as a Starting Point

Aspects of the present disclosure include methods and systems that use a selection of multiple tags, multiple images, or a combination thereof by a user or a group of users when initiating a search or a recommendation. Such a selection can be used by the methods and systems to narrow the search of the number of tags or images or both from which to select in the process of providing a recommendation. For example, a user can choose 5 or more tags or images or combinations of both that inform the algorithm that some combination or minimum number of the tags must be in one or more images presented to user. In one or more embodiments, a user may indicate one or multiple tags from a pool of tags that must be embedded/associated with an image as a condition for an image or item represented by an image to be presented during a search session. In one or more embodiments, a user may indicate some minimum number or all of the selected tags to be associated with all images or items represented and presented in a search session. For example, a user can select 5 tags from a universe of tags, of which images must contain at least 1 through 5 of the tags. In one or more embodiments, a user may indicate one or multiple tags from a universe of tags that must be excluded from, or not associated with an image as a condition for an image or item to be presented during a search session. A user may indicate some minimum number or all of selected tags to be excluded or absent from all images or items presented in a search session. For example, a user can select two tags (e.g., yellow and green) from a universe of tags, where no presented images or items shall contain either yellow and green tags.

For example, in one or more embodiments, a user can begin by inputting a tag Sweater, which can represent a category of images, or a sub-category from a universe of images. Prior to presentation of first image, a user can also select from a pool of tags, or cause to enter a minimum number tags (e.g., pink, short sleeve, and cashmere) that must be included in the tags associated with each image. Thus, rather than starting with a random item, the session can choose five or more tags that tells the algorithm that some combination or minimum of named beginning tags must be in images presented to user.

### Basis

Aspects of the present disclosure include methods and systems that provide representations of tags and allow the user, or a group of users, to provide the basis for a preference. In one or more embodiments, the methods and systems display or make known to the user, such as via text overlay or other visual/audio cues, tags/descriptive attributes (metadata), etc. the tags associated with each image presented. In addition to providing the preference of an image, and prior to being presented the next image, the user can identify relevant tags that caused the decision of the preference of the image. For example, the user could tap a tag to support a positive response to an image, which provides a basis for image. The same is true for a negative response to an image. For example, after the user provides a negative response, the user can provide an input that provides the tag that was the basis of the preference.

In response to being provided the basis of a preference, the methods and systems can record the user's responses to tags presented in a given session by virtue of the tags' associations with each single image or represented item. The methods and systems can also record the user's preference of tags associated with each image as a “decision-making” preference. For example, each image may have been accepted (because it was “blue”), or rejected (because it was “round”). The methods and systems can store the basis for the preference and subsequently use this basis information to affect weighting in the ongoing session and/or future sessions. One or more tags that serve as the basis for the preference can have their weighting change during the session and/or for future sessions. For example, in one or more embodiments, a tag that serves as the basis for a single positive preference can have its weighting increased to correspond with the positive preference. In one or more embodiments, a tag that serves as the basis for multiple positive preferences can have its weighting increased to correspond with the multiple positive preferences. For example, there can be a threshold number of times a tag is associated with a positive preference before the weighting of the tag is increased. The same situations can occur for reducing the weighting of a tag in response to a tag being the basis for a negative preference for one and/or multiple times.

In one or more embodiments, the methods and systems can provide the basis information to one or more entities or vendors associated with the items. The basis information can be tied to the items, the users, or both. Providing the basis information to the entities or vendors provides greater insight for the entities or vendors on why users like or dislike their items. Providing the basis information also provides greater insight to the entities or vendors on the users, if the basis information is tied to the user. In one or more embodiments, for privacy concerns, the basis information can be tied to a user in a way such that the entities or vendors cannot identify the actual user but can still track the preferences and bases of the user.

In one or more embodiments, the basis can be more granular than a single or primary basis for an item represented by an image. For example, for a given item, there can be aspects of the item for which the user has a positive preference and aspects of the item for which the user has a negative preference. The basis that a user can provide in response to the item can be more granular for allowing the user to capture the granularity of the basis. The user can provide a preference for each tag associated with an item, or for one or more tags associated with the item. This allows a user to provide a more granular basis for the item overall. This also allows a user to provide preferences for tags that may contradict the preference for the item overall.

For example, an item may be associated with five tags. A user may provide a positive preference for the item overall. However, the user may provide a negative preference for one or more of the five tags if the user has a negative preference for aspects of the item associated with the one or more tags. Tied to a specific example, the item may be a dress. A user may like the style of the dress, the shape of the dress, and the color of the dress. However, the user may not like the material used to make the dress. In which case, the user can provide a positive preference for the tags associated with the style, shape, and color, but a negative preference for the tag associated with the color. Rather than all of the tags being weighted according to the preference provided for the item, the tags can be weighted according to their own specific preferences. This can help guide the methods and devices to an outcome that the user may better prefer.

In one or more embodiments, the preference for the tags can be more granular than positive or negative. The preference can be any preference disclosed herein, such as positive, neutral, and negative. In one or more embodiments, the tags can be ranked from positive to negative, or vice versa, or from lowest to highest, or vice versa. In one or more embodiments, the tags can be ranked within a scale of positive to negative, such as highly negative, moderately negative, neutral, moderately positive, and highly positive. This allows a user to provide with more granularity the aspects of the item that the user likes.

In one or more embodiments, an item may be a combination of smaller items. The same tagging and preference providing can be applied to the combination of smaller items. For example, an item may show a model wearing an outfit. The user may have a positive preference for the outfit. However, the outfit may include a jacket, pants, a belt, and shoes. Despite a user liking the outfit overall, the user may not like the shoes. In which case, the user can provide a negative preference for one or more tags associated with the shoes. The user can similarly provide positive preferences for one or more tags associated with the other aspects of the outfit, such as the jacket, pants, and belt.

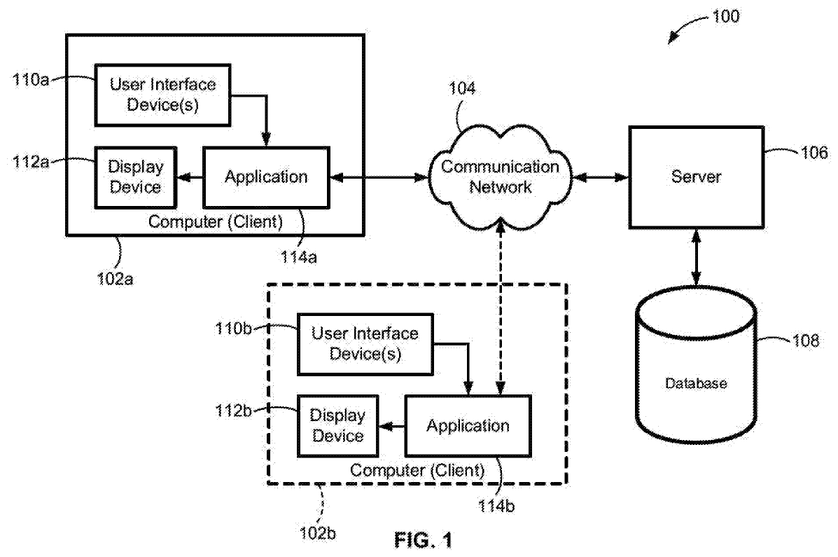

FIG. 1 is a functional block diagram of a system 100 according to an aspect of the present disclosure. First, the general components of the system 100 will be introduced, followed by examples. The system 100 includes one or more electronic computers (clients) 102a, 102b. Reference numbers used herein without a letter can refer to a specific one of the plurality of items, a subset of multiple items of the plurality of items, or all items of the plurality of items so numbered with the same reference number. Thus, by way of example, the reference number 102 can refer to the computer 102a, the computer 102b, or both of the computers 102a and 102b, as shown in FIG. 1. The one or more computers 102a, 102b connect to a communication network 104, such as the Internet. However, the communication network 104 can be any type of electronic communication network. A computer as used herein includes any one or more electronic devices having a central processing unit (CPU) or controller or microprocessor or microcontroller as understood by those skilled in the art of electronic computers. Examples of computers include tablet computers, laptop computers, desktop computers, servers, smartphones, a wearable electronic device such as a watch, an eyeglass, an article of clothing, or a wristband, and personal digital assistants (PDAs). The term computer as used herein can include a system of electronic devices coupled together to form what is conventionally referred to as a computer. For example, one or more input devices, such as a keyboard or a mouse, and one or more electronic display devices, such as a video display, can be coupled to a housing that houses the CPU or controller. Or, all components of the computer can be integrated into a single housing, such as in the case of a tablet computer or a smartphone. The one or more computers 102a, 102b conventionally include or are operatively coupled to one or more memory devices that store digital information therein, including non-transitory machine-readable instructions and data.

The one or more computers 102a, 102b include user interface devices 110a, 110b. Each user interface device 110a, 110b corresponds to a human-machine interface (HMI) that accepts inputs made by a human (e.g., via touch, click, gesture, voice, etc.) and converts those inputs into corresponding electronic signals. Non-limiting examples of user interface devices 110a, 110b include a touchscreen, a keyboard, a mouse, a camera, and a microphone. These are also referred to as human-machine interface devices, because they allow a human to interact with a machine by providing inputs supplied by the human user to the machine.

The one or more computers 102a, 102b also include electronic display devices 112a, 112b that are configured to display information that can be visually perceived. Non-limiting examples of display devices 112a, 112b include an electronic video display, a stereoscopic display, or any electronic display configured to visually portray information including text, static graphics, and moving animations that is perceivable by the human eye. The electronic display devices 112a, 112b display visual information contained in an electronic user interface (UI). The electronic UI can also include selectable elements that are selectable using the one or more HMI devices 110a, 110b. Thus, the electronic UI generally can include a graphical user interface (GUI) component and a human-machine user interface component, via which a human user can select selectable elements displayed on the GUI via the HMI interface.

The one or more computers 102a, 102b also include software applications 114a, 114b. That is, the one or more computers 102a, 102b execute non-transitory machine-readable instructions and data that implement the software applications 114a, 114b. The applications 114a, 114b perform one or more functions on the one or more computers 102a, 102b. The applications 114a, 114b can be various specific types of applications, such as a web browser application or a native application. Within the system 100, the applications 114a, 114b convey information between the one or more computers 102a, 102b and the communication network 104 (e.g., Internet) via a conventional wired or wireless electronic communications interface associated with the one or more computers 102a, 102b. Alternatively, or in addition, the applications 114a, 114b can be a native application. Native applications convey information between the one or more computers 102a, 102b over the communication network 104 to an application server 106. The native applications 114a, 114b conventionally convey information between the one or more computers 102a, 102b over the communication network 104 via a conventional wired or wireless electronic communications interface associated with the one or more computers 102a, 102b.

As described above, the server 106 is also coupled to the communication network 104. The server 106 is a type of computer, and has a well understood meaning in the art. The server 106 can be, for example, a web browser server, such as in the case of applications 114a, 114b being web browser applications. Or, the server 106 can be, for example, a native application server, such as in the case of applications 114a, 114b being native applications.

An electronic database 108 is incorporated in or is coupled to the server 106. The database 108 is a form of a memory device or a data store, and stores electronic data for retrieval and archival relative to the server 106. Both the server 106 and the one or more applications 114a, 114b communicate information according to one or more protocols, such as the hypertext transfer protocol (HTTP) in the case of the communication network 104 being the Internet. In the case of the communication network 104 being a private local area network (LAN), instead of the Internet, any other communications protocol can be used instead of the HTTP. For example, native applications can instead communicate using a proprietary or conventional communications protocol to pass information between the one or more computers 102a, 102b and the server 106.

Although the system 100 is shown generally with respect to FIG. 1 as including two computers 102a, 102b, one server 106, and one database 108, the system 100 can include any number of computers 102a, 102b, any number of independent or clustered servers 106 (e.g., server farm or sever cluster), and any number of databases 108. Moreover, some or all functionality of one or more components of the system 100 can be transferred, in whole or in part, to other components of the system 100. By way of example, functionality of the server 106 and/or the database 108 can be transferred, in whole or in part, to the one or more computers 102a, 102b, depending on the functionality and performance of the computers 102a, 102b.

The applications 114a, 114b communicate with the server 106 and the database 108 over the communication network 104 for analyzing tags associated with a sequence of images presented to a user to guide a user to a current interest. The applications 114a, 114b control the user interface devices 110a, 110b and the display devices 112a, 112b to present the images to the user and to receive inputs from the user indicating the user's preferences for the images. The images are communicated over the communication network 104 to the applications 114a, 114b of the one or more computers 102a, 102b from the database 108, either directly or through the server 106. Accordingly, based on a client-server arrangement of the system 100, with the computers 102a, 102b as the clients and the server 106 as the server, the database 108 stores the information used for analyzing tags associated with a sequence of images presented to a user to guide a user to a current interest. The server 106 performs the functionality of the algorithms described herein, including serving the information from the database 108 to the clients (e.g., computers 102a, 102b). The computers 102a, 102b present the information to the user and receive the inputs from the users, which are then presented to the server 106 for processing. However, the functionality disclosed herein with respect to the disclosed algorithms can be divided among the components of the system 100 differently than as explicitly disclosed, without departing from the present disclosure. For example, all of the functionality disclosed herein can be embodied in one or more of the computers 102a, 102b, such as the computers 102a, 102b being arranged as a distributed network, depending on the capability of the computers 102a, 102b.

As one facet of the information, the database 108 electronically stores the electronic images within a data store of images. The images can be of various file formats and image types. By way of example, the file formats can include JPEG, Tagged Image File Format (TIFF), Portable Network Graphics (PNG), etc. The image types can include digital photographs, digital drawings, icons, etc. However, as discussed throughout as being images, other file types can be used besides images, such as file types supporting video, audio, etc. As discussed above, the images stored on the database 108 represent an item that may be of interest to the user. Accordingly, the images visually convey information to the user so that the user understands the items that the images represent. The system 100 can initially include a set number of images. The set number of the images can be defined by the administrator of the system 100. As described below, the system 100 also allows for users to add additional images to the system 100. For example, users can upload images from the one or more computers 102a, 102b to add additional images to the database 108. As the users interact with the system 100, and the users upload images to the system 100, the number of images increases.

For each image, the database 108 stores information regarding the item that the image represents. The item can be any tangible or intangible item that is representable by an image. By way of example, and without limitation, the items can be food dishes; consumer goods, such as clothing, automobiles, etc.; physical locations, such as vacation spots, museums, sports venues, etc.; songs, books, movies, television programs, etc. However, as understood by one of ordinary skill in the art, the disclosure is not limited to any particular item. Rather, each item can be any item represented by an image such that a user can identify the item when presented the image.

Although reference is made throughout to the item and an image representing the item, the item can be represented by something other than an image. For example, in one or more embodiments, the item can be represented by a sound or a song, a video, a scent, a touch, etc. These representations can relate to senses of the user other than sight. For example, a sound triggers the sense of hearing, a scent triggers the sense of smell, a touch triggers the sense of touch, etc. Further, the sense of sight can be triggered by more than just a static image by use instead of a video, an animation, etc. Thus, the items can be represented by file types other than just image files, but any file corresponding to any one of the above forms of representing the item.

The database 108 also stores electronic tags. Tags are used within the system 100 to describe and/or characterize the item that is represented by an image. The tags can include single words or several words linked together as a tag that describe or characterize the item overall (e.g., general attributes), or that describe or characterize sub-components or sub-aspects (e.g., specific attributes) of the item. The tags can also summarize objective or subjective responses or reaction of user, in general, to the item. Accordingly, for each image, the image is associated with a set of tags that describe or characterize the item.

The database 108 stores all of the tags within a pool of tags, which is the totality of tags that can be associated with an image to describe a characteristic and/or a quality (e.g., attribute) of the item that is represented by the image. The tags can be any type of descriptor of the item represented by the image, such as a noun, an adjective, etc. Each image is associated with at least one tag, but can be associated with any number of tags.

The tags can be objective, subjective (or semi-subjective), or tangential regarding how the tags describe or characterize the item that is associated with the image. Objective tags apply to all users. Partially subjective tags can apply to all users or a subset of users. Tangential tags may describe aspects of the item only when correlated with other information. Such other information may only be known or apply to a subset of users that interact with the system 100. By way of example, such tags may be terms currently trending in social media, such as hashtags on TWITTER® that apply to only a subgroup of users that are following the current social media trends. Such tags include, for example, hipster, yolo, GenY, GenX, etc. Independent of the context of the tag, these tangential tags do not necessarily apply to an item. However, patterns may develop that allow certain tangential tags to be understood as referring to a quality or characteristic of an item.

Like the images, the system 100 initially begins with a certain number of tags. However, the group of tags can be dynamic and evolve as the users interact with the system 100. For example, additional tags can be added to the pool of tags as users upload new images of items to the system 100 and describe the items based on new tags that the users create. The users can create additional tags to describe or characterize the item that is associated with the image that the users uploaded. Each image is associated with one or more of the tags from among the group of tags as a set of tags for the image. The association can be based on an administrator of the system 100 associating the tags with the images. Alternatively, or in addition, the association can be based on users of the system 100 associating the tags with the images and/or creating new tags. The associations can be manual, such as the users manually selecting a tag to associate with an image. Alternatively, or in addition, the associations can be automatic, such as the system 100 automatically determining tags that apply to images.

Based on the images being associated with multiple tags as a set of tags, the database 108 can also store information pertaining to specific sets of tags. A specific combination of tags is a set of tags. A single set of tags can describe multiple different images based on the generality of each tag and an image being associated with any number of tags. The database 108 may include a data structure, such as a table, to track the various sets of tags based on the various associations between tags and images within the database 108.

The database 108 also stores and tracks associations between elements of the system 100, such as between tags, between sets of tags, between images and tags and/or sets of tags, between users and the elements, etc. The system 100 can associate a tag with an image based on the image already being associated with another tag, and both of the tags including an association. The associations can develop as the number of images that represent different items increases within the database 108, or as more users interact with the tags and with the images.

As will be also described below, along with the image, one or more user interface elements or items can be optionally presented on the display device 112a of the computer 102a to allow the user to indicate a preference or inclination/disinclination for the item that is represented by the image. The user interface elements may vary depending on the functionality/capability of the computer device 102a, the user interface device 110a, and/or the display device 112a. Alternatively, the display device 112a may not present graphical user interface elements (although it could) specifically for the user indicating the preference for the item. Rather or additionally, for example, it may be implicit what action the user should take to indicate the preference, such as by swiping left on or near the image or anywhere on the display device 112a to indicate a negative preference (e.g., dislike) and swiping right on or near the image or anywhere on the display device 112a to indicate a positive preference (e.g., like), or vice versa. To be clear, the present disclosure also contemplates displaying graphical UI elements (e.g., like and dislike virtual buttons displayed on the display device 112 for selection using a user interface device 110); recognizing gestures (e.g., swiping) made by a user relative to a user interface device 110, with or without (e.g., hand gestures) contacting the user interface, including the ability for a user to provide gestures for selection in a virtual or augmented reality setting; or any other visual (e.g., retinal scan determining an rea of focus of the user relative to one or more images or UI elements presented on a display); mechanical; or audible (e.g., voice command) scheme for indicating a preference.

The database 108 also stores user profiles. Generally, the user profiles include information that is used for interacting with the system 100. Such information can include certain tags indicated by the user to include with the user's profile and images, items, and/or entities for which the user has indicated a positive or a negative preference, independent of or dependent of the user interacting with images presented to the user during a session of analyzing tags associated with a sequence of images presented to a user.

The user can indicate such preferences through a manual selection of the tags. Alternatively, or in addition, such preferences can be learned by the system 100 during the user's interaction with the system 100 over a period of time, such as through an implicit selection of the tags as preferred tags through the user indicating over time a preference for the tags. The preference can be indicated according to a YES/NO schema, such as the user does or does not like a tag, an image, and/or an item. Alternatively, the preference can be indicated according to a weighted schema, such as a degree to which the user does or does not like a tag, image, and/or item.

The profile information can include any other additional information associated with a user, such as the user's name, address, gender, age, ethnicity, religion, etc. The system 100 tracks such additional information to mine trends across the users for tags, images, and/or items. For example, the system 100 tracks user's interactions within the system 100 to develop a user history. The user history tracks interactions between the user and the system 100 and allows the user to review the previous interactions. By way of example, the user history can include information pertaining to the user's preference to specific images that were previously presented to the user.

In one or more embodiments, profiles can be generated passively by the method and devices recording user preferences to images and tags as the user interacts with the methods and devices. In one or more embodiments, a user can modify the profile, either after being generated by the user or passively by the methods and devices. The user can manually add preferences for one or more items, one or more tags, or both. In one or more embodiments, the user can modify the weighting of one or more tags associated with the user's profile, including resetting the weighting of one or more or all of the tags. For example, in one or more embodiments, a user can modify the tag for the color “pink” according to a “like” scale for never, rarely, occasionally, frequently, most of the time, or all of the time. The degrees of like can be associated with the weighting values of 0, 1, 2, 3, 4, and 5, respectively. In one or more embodiments, the profile can be generic to the items, the tags, and the vendors or entities providing the items. Alternatively, in one or more embodiments, there can be specific profiles for specific items, tags, and vendors or entities. A user can select a profile that is pre-configured for one or more items or item types, one or more tags or tag types, and/or one or more vendors or entities that provide the items. Pre-configured profiles can include a subset of items, tags, and/or entities or vendors that can be presented to a user during a session.

In one or more embodiments, profiles could be shared (such as with user consent) with vendors or entities to assist in the efficiency/accuracy of user searches for items sold by an entity.

As discussed above, the images represent items that are offered by various entities. The database 108 includes information with respect to the location of the entity associated with the item and/or the image that represents the item. By way of example, the item can represent an object for sale and the physical entity represents the store that offers the object for sale. The database 108 includes information with respect to the location of the store. In addition to the location, the database 108 can also include entity profiles. According to some embodiments, the entity profiles can be organized according to a subscription-based system. According to some embodiments, user interactions with the system 100 will allow for the users to confirm the information presented in the entity profiles. The entity profiles can also include images to showcase the entity's items, additional links leading to their websites or social media applications (e.g., FACEBOOK®, TWITTER®), etc.

The entity profiles allow users to browse the entities and click on a suggested or profiled entity, leading the user to the entity's profile. As part of the above-described associations, the system 100 collects and shares visitor frequency with entities when users are redirected to the entities' websites following selection of images associated with items that are associated with the entities. According to some embodiments, the entity profiles will include a direct purchasing interface for users, thereby obviating the need for users to seek third party companies to order or consume items associated with the entity.

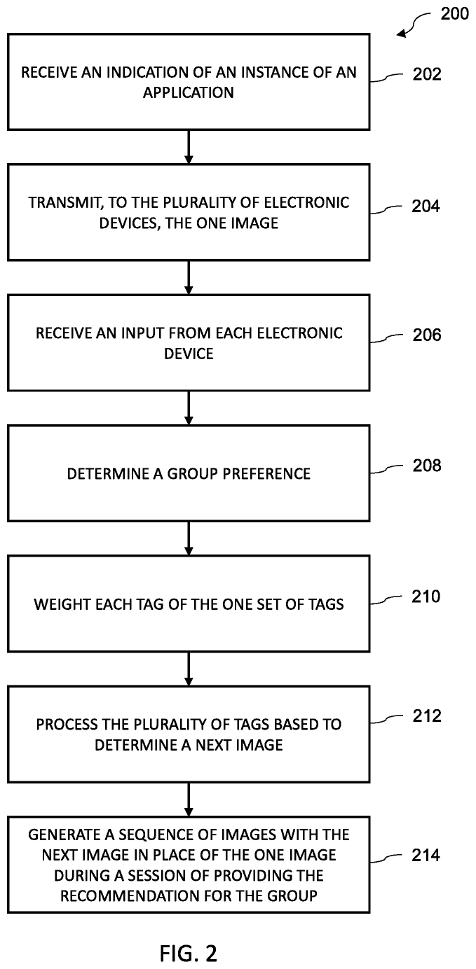

FIG. 2 is a flowchart of a computer-implemented method or algorithm 200 for providing a recommendation for a group, using aspects of the present disclosure including the one or more computers 102a, 102b, the server 106, and the database 108. The computer-implemented method or algorithm 200 may be executed within a computer 102a, the server 106, the database 108, or across multiple platforms, such as on the computer 102a and the server 106. In regard of the latter arrangement, an application 114a executed by the computer 102a (e.g., client-side application) may perform the computer-implemented method or algorithm 200 in conjunction with an application executed on the server 106 (e.g., server-side application) according to a client-server relationship.

The computer-implemented method or algorithm 200 begins at 202 where the hardware implementing the computer-implemented method or algorithm 200 receives an indication, from a plurality of electronic devices associated with a plurality of users (e.g., one or more computers 102a, 102b), of an instance of an application executed on each electronic device of the plurality of electronic devices. The plurality of indications identifies the plurality of electronic devices as belonging to the group. In one or more embodiments, prior to receiving the indication, the computer-implemented method or algorithm 200 can receive, from one electronic device, among the plurality of electronic devices, associated with one user from the plurality of users, a request to invite a remainder of the plurality of users to form the group. In response, the computer-implemented method or algorithm 200 can transmit invitations to electronic devices associated with the remainder of the plurality of users to join the group. The indications from the electronic devices associated with the remainder of the plurality of users can correspond to acceptances of the invitations.

The computer-implemented method or algorithm 200 continues at 204 where the hardware implementing the computer-implemented method or algorithm 200 transmits one image, from among a plurality of images, to the plurality of electronic devices. The one image is associated with one or more sets of tags from among a plurality of tags, each tag of the one or more sets of tags describing or characterizing attributes of the one image. Although described as “one or more sets of tags,” in one or more embodiments, the tags within the one or more sets of tags can instead be considered in a single set of tags (or one set of tags) that encompasses the one or more sets. Thus, use of “one set of tags” and “one or more sets of tags” can be interchangeable where not otherwise limited.

The computer-implemented method or algorithm 200 continues at 206 where the hardware implementing the computer-implemented method or algorithm 200 receives, from the plurality of electronic devices, an input from each electronic device of the plurality of electronic devices indicating a preference for the one image for each user of the plurality of users. For example, upon the image being presented (e.g., displayed on the display devices 112) to the users, the computer-implemented method or algorithm 200 receives an input from each user indicating a preference for the item represented by the image. The preference may be a like or an inclination toward the item (e.g., positive) or dislike or a disinclination against the item (e.g., negative). Alternatively, the preference may be like (e.g., positive), dislike (e.g., negative), or neither like nor dislike (e.g., neutral). A neutral preference may indicate that the user cannot tell whether he or she likes or dislikes the item represented by the image. Alternatively, the preference may be scaled, such as a range of 1 to 10 to indicate the degree that the user likes (e.g., 6 to 10) or dislikes (e.g., 1 to 5) the item represented by the image. In one or more embodiments, the input can be a default input. The default input can be set to a positive preference, a neutral preference, or a negative preference. The default input can be, for example, transmitted from an electronic device and received by the hardware implementing the computer-implemented method or algorithm 200 in the event that a user does not select a preference. In one or more embodiments, the default preference may be given if the user does not select a preference after an image is presented for a set period of time. This will allow the group to continue determining a recommended item despite one or more users within the group not providing responses to images. In one or more embodiments, the default preference can be saved within a profile associated with the user, which allows the user to select, for example, positive, neutral, or negative as the default response.

The computer-implemented method or algorithm 200 continues at 208 where the hardware implementing the computer-implemented method or algorithm 200 determines a group preference based on the plurality of preferences for the one image. In one or more embodiments, the group preference can be an average of the preferences of the users, the mode of the preferences of the users, or other types of combinations.

The computer-implemented method or algorithm 200 continues at 210 where the hardware implementing the computer-implemented method or algorithm 200 weights each tag of the one or more sets of tags based, at least in part, on the group preference. In one or more embodiments, the weighting can include the computer-implemented method or algorithm 200 incrementing a weight of each tag of the one or more sets of tags a positive value based, at least in part, on the group preference being positive. The weighting can further include the computer-implemented method or algorithm 200 decrementing the weight of each tag of the one or more sets of tags a negative value based, at least in part, on the group preference being negative. In one or more embodiments, each preference of the one image is assigned separate numerical values based on a positive preference and a negative preference, and the group preference is an average of the numerical values. In one or more embodiments, the numerical value for the positive preference is 1 and the numerical value for the negative preference is −1. However, one or more other numerical values can be used, and the present disclosure is not limited to 1 and −1.

In one or more embodiments, one or more additional tags, outside of the one or more sets of tags, can be weighted based, at least in part, on the group preference and associations with at least one tag within the one or more sets of tags. The weighting, therefore, can go beyond the tags within the one or more sets of tags. For example, the tag “spicy” can be a tag within the one or more sets of tags. Based on the group preference, the tag “spicy” can be weighted, such as a weight of 1 in response to a positive preference. Although not within the one or more sets of tags, the tag “hot” can have an association with the tag “spicy” because, for example, both tags indicate a similar attribute with respect to food. In which case, the method or algorithm 200 can provide the same weight to the tag “hot,” despite the tag not being in the one or more sets of tags, because of the relationship with the tag “spicy,” which is within the one or more sets of tags. As an additional example, if a user were to express a high preference for maternity clothes, tags within the one or more sets of tags that are attributes of maternity clothes can be weighted higher. Tags that are attributes to baby clothes can have associations with tags that are attributes of maternity clothes. Accordingly, the tags that are attributes of baby clothes can be weighted higher based on their association with tags that are attributes of maternity clothes, despite the baby clothes tags not being within the one or more sets of tags during an iteration of the method or algorithm 200.

The computer-implemented method or algorithm 200 continues at 212 where the hardware implementing the computer-implemented method or algorithm 200 processes the plurality of tags based, at least in part, on the weighted tags of the one or more sets of tags, the group preference, or a combination thereof to determine a next image from the plurality of images, the next image being different from the one image. In one or more embodiments, the processing can further include the computer-implemented method or algorithm 200 determining a next set of tags based, at least in part, on the weighted tags of the one or more sets of tags. The computer-implemented method or algorithm 200 can further determine the next image from the plurality of images based, at least in part, on the next image being associated with each tag of the next set of tags. In one or more embodiments, the next set of tags includes highest weighted tags from the plurality of tags and one or more additional tags.

The computer-implemented method or algorithm 200 continues at 214 where the hardware implementing the computer-implemented method or algorithm 200 generates a sequence of images by repeating the transmitting, the receiving, the determining, the weighting, and the processing with the next image in place of the one image during a session for providing the recommendation for the group.

In one or more embodiments, the computer-implemented method or algorithm 200 can stop once it is determined that a weighting of at least one tag from the plurality of tags has attained a threshold value. Subsequently, the computer-implemented method or algorithm 200 can determine at least one image from the plurality of images that is associated with the at least one tag. The computer-implemented method or algorithm 200 can further provide the at least one image as the recommendation to the group.

In one or more embodiments, the computer-implemented method or algorithm 200 can stop once it is determined that one or more users of the group, or a majority of the group, or an entirety of the group has made a selection. For example, one or more users can provide a selection in response to an image indicating that the presented item is his or her selection. The computer-implemented method or algorithm 200 can then find an item that matches the tags of the selection. When more than one user provides a selection, the computer-implemented method or algorithm 200 can find the best solution of which items satisfies all or most of the users' selections.

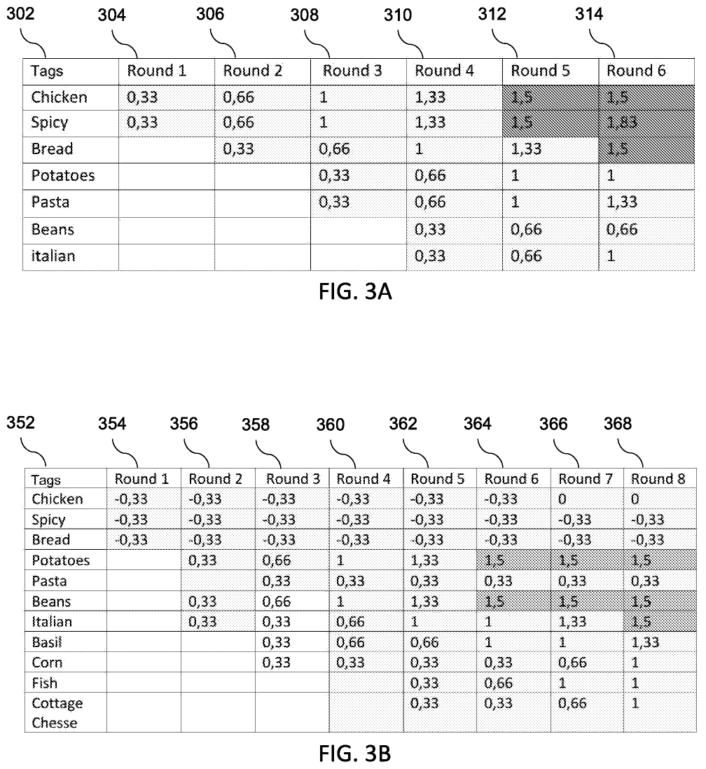

FIG. 3A illustrates the weighting of tags for providing a recommendation for a group according to aspects of the present disclosure over the course of, for example, a session of the computer-implemented method or algorithm 200. The flow begins with a plurality of tags 302. Each image that is displayed is associated with a combination of the plurality of tags 302, and is presented to the user at the computer 102a through execution of the application 114a. Specifically, the display device 112a displays the image that is associated with a set of tags from the plurality of tags 302. The tags 302 can be any of the above-described tags; however, for purposes of convenience, the tags are represented by the terms in the first column in the order as described in columns 304 through 314. That is, the first column 302 lists the tags, and columns 304 through 314 list the rounds of the iterative display of images and the resulting values assigned to the tags associated with the images. In the context of the session represented by FIG. 3A, all tags 302 begin with a weight of zero, a positive preference for an image displayed to a user represents a value of 1 for the user, as applied to each tag, and a negative preference for an image displayed to a user represents a value of −1 for the user, as applied to each tag. The session represented by FIG. 3A begins with Round 1, represented by column 304.

In Round 1, an image is presented to Users A through C that is associated with the tags Chicken and Spicy. In response, Users A and B provide a positive preference for the image displayed during Round 1, and User C provides a negative preference for the image displayed during Round 1. The average of the three preferences is determined based on the average of the values 1, 1, and −1, which is determined as 0.33. This is the preference of the group of Users A through C. The preference 0.33 is assigned to the tags Chicken and Spicy.

In Round 2, represented by column 306, a second image is presented to User A through C. The image is selected based on including the tags Chicken and Spicy based on the positive group preference for Round 1. The image is also selected based on including an additional tag of, for example, Bread. In response, Users A through B provide a positive preference for the image displayed during Round 2, and User C provides a negative preference for the image displayed during Round 2. Again, the average of the three preferences is determined based on the average of the values 1, 1, and −1, which is determined as 0.33. This is the preference of the group of Users A through C for the image of Round 2. The preference 0.33 is added to the previous values of the tags Chicken and Spicy, and added to the tag of Bread. The result is the weight of 0.66 for the tags Chicken and Spicy, and the weight of 0.33 of the tag Bread.

In Round 3, represented by column 308, a third image is presented to User A through C. The image is selected based on including the tags Chicken, Spicy, and Bread based on the positive group preference for Round 2. The image is also selected based on including, for example, additional tags of, for example, Potatoes and Pasta. In response, Users A through B provide a positive preference for the image displayed during Round 3, and User C provides a negative preference for the image displayed during Round 3. Again, the average of the three preferences is determined based on the average of the values 1, 1, and −1, which is determined as 0.33. This is the preference of the group of Users A through C for the image of Round 3. The preference 0.33 is added to the previous values of the tags Chicken, Spicy, and Bread, and added to the tags of Potatoes and Pasta. The result is the weight of 1 for the tags Chicken and Spicy, the weight of 0.66 for the tag Bread, and the weight of 0.33 for the tags of Potatoes and Pasta.

In Round 4, represented by column 310, a fourth image is presented to User A through C. The image is selected based on including the tags Chicken, Spicy, Bread, Potatoes, and Pasta based on the positive group preference for Round 3. The image is also selected based on including additional tags of, for example, Beans and Italian. In response, Users A through B provide a positive preference for the image displayed during Round 4, and User C provides a negative preference for the image displayed during Round 4. Again, the average of the three preferences is determined based on the average of the values 1, 1, and −1, which is determined as 0.33. This is the preference of the group of Users A through C for the image of Round 4. The preference 0.33 is added to the previous values of the tags Chicken, Spicy, Bread, Potatoes, and Pasta and added to the tags of Beans and Italian. The result is the weight of 1.33 for the tags Chicken and Spicy, the weight of 1 for the tag Bread, the weight of 0.66 for the tags of Potatoes and Pasta, and the weight of 0.33 for the tags of Beans and Pasta.

In Round 5, represented by column 312, a fifth image is presented to User A through C. The image is selected based on including the tags Chicken, Spicy, Bread, Potatoes, Pasta, Beans, and Italian based on the positive group preference for Round 4. In response, Users A through B provide a positive preference for the image displayed during Round 5, and User C provides a negative preference for the image displayed during Round 5. Again, the average of the three preferences is determined based on the average of the values 1, 1, and −1, which is determined as 0.33. This is the preference of the group of Users A through C for the image of Round 5. The preference 0.33 is added to the previous values of the tags Chicken, Spicy, Bread, Potatoes, and Pasta and added to the tags of Beans and Italian. The result is the weight of 1.5 for the tags Chicken and Spicy, the weight of 1.33 for the tag Bread, the weight of 1 for the tags of Potatoes and Pasta, and the weight of 0.66 for the tags of Beans and Pasta.

In Round 6, represented by column 314, a sixth image is presented to User A through C. The image is selected based on including the tags Spicy, Bread, Pasta, and Italian. In response, Users A through C provide a positive preference for the image displayed during Round 6, and User C provides a negative preference for the image displayed during Round 6. Again, the average of the three preferences is determined based on the average of the values 1, 1, and −1, which is determined as 0.33. This is the preference of the group of Users A through C for the image of Round 6. The preference 0.33 is added to the previous values of the tags Spicy, Bread, Pasta, and Italian. The result is the weight of 1.83 for the tags Spicy, the weight of 1.5 for the tag Bread, the weight of 1.33 for the tag Pasta, and the weight of 1 for the tag of Italian.

In one or more embodiments, the session represented by FIG. 3A can stop once one or more tags reaches a weight of, for example, 1.5. In one or more embodiments, the session represented by FIG. 3A can stop once at least three tags reaches a weight of, for example, 1.5. In the particular example of FIG. 3A, the session stops after the tags of Chicken, Spicy, and Bread reach the weight of 1.5. In which case, the process can recommend an image that includes the tags of Chicken, Spicy, and Bread.

FIG. 3B illustrates the weighting of tags for providing a recommendation for a group according to aspects of the present disclosure over the course of, for example, a session of the computer-implemented method or algorithm 200. The flow begins with a plurality of tags 352. Each image that is displayed is associated with a combination of the plurality of tags 352, and is presented to the user at the computer 102a through execution of the application 114a. Specifically, the display device 112a displays the image that is associated with a set of tags from the plurality of tags 352. The tags 352 can be any of the above-described tags; however, for purposes of convenience, the tags are represented by the terms in the first column in the order as described in columns 354 through 368. That is, the first column 352 lists the tags, and columns 354 through 368 list the rounds of the iterative display of images and the resulting values assigned to the tags associated with the images. In the context of the session represented by FIG. 3B, all tags 302 begin with a weight of zero, a positive preference for an image displayed to a user represents a value of 1 for the user, as applied to each tag, and a negative preference for an image displayed to a user represents a value of −1 for the user, as applied to each tag. The session represented by FIG. 3B begins with Round 1, represented by column 354.

In Round 1, an image is presented to Users A through C that is associated with the tags Chicken, Spicy, and Bread. In response, Users A and B provide a negative preference for the image displayed during Round 1, and User C provides a positive preference for the image displayed during Round 1. The average of the three preferences is determined based on the average of the values −1, −1, and 1, which is determined as −0.33. This is the preference of the group of Users A-C. The preference −0.33 is assigned to the tags Chicken, Spicy, and Bread.

In Round 2, represented by column 356, a second image is presented to Users A through C. The image is selected based on excluding the tags Chicken, Spicy, and Bread based on the negative group preference for Round 1. In the alternative, the image is selected based on including the tags of, for example, Potatoes, Beans, and Italian. In response, Users A through B provide a positive preference for the image displayed during Round 2, and User C provides a negative preference for the image displayed during Round 2. Again, the average of the three preferences is determined based on the average of the values 1, 1, and −1, which is determined as 0.33. This is the preference of the group of Users A through C for the image of Round 2. The preference 0.33 is added to the weight of the tags Potatoes, Beans, and Italian.

In Round 3, represented by column 358, a third image is presented to Users A through C. The image is selected based on including the tags Potatoes and Beans based on the positive group preference for Round 2. The image is also selected based on including, for example, additional tags of, for example, Pasta, Basil, and Corn. In response, Users A through B provide a positive preference for the image displayed during Round 3, and User C provides a negative preference for the image displayed during Round 3. Again, the average of the three preferences is determined based on the average of the values 1, 1, and −1, which is determined as 0.33. This is the preference of the group of Users A through C for the image of Round 3. The preference 0.33 is added to the weights of Potatoes, Beans, Pasta, Basil, and Corn.

In Round 4, represented by column 360, a fourth image is presented to User A through C. The image is selected based on including the tags Potatoes, Beans, and Basil based on the positive group preference for Round 3. The image is also selected based on including additional tags of, for example, Italian. In response, Users A through C provide a positive preference for the image displayed during Round 4, and User C provides a negative preference for the image displayed during Round 4. Again, the average of the three preferences is determined based on the average of the values 1, 1, and −1, which is determined as 0.33. This is the preference of the group of Users A through C for the image of Round 4. The preference 0.33 is added to the weights of Potatoes, Beans, Basil, and Italian.

In Round 5, represented by column 362, a fifth image is presented to User A through C. The image is selected based on including the tags Potatoes, Beans, and Italian based on the positive group preference for Round 4. The image is also selected based on including additional tags of, for example, Fish and Cottage Cheese. In response, Users A through C provide a positive preference for the image displayed during Round 5, and User C provides a negative preference for the image displayed during Round 5. Again, the average of the three preferences is determined based on the average of the values 1, 1, and −1, which is determined as 0.33. This is the preference of the group of Users A through C for the image of Round 5. The preference 0.33 is added to the weights of Potatoes, Beans, Italian, Fish, and Cottage Cheese.

In Round 6, represented by column 364, a sixth image is presented to Users A through C. The image is selected based on including the tags Potatoes, Beans, and Fish. The image is also selected based on including additional tags of, for example, Basil. In response, Users A through C provide a positive preference for the image displayed during Round 6, and User C provides a negative preference for the image displayed during Round 6. Again, the average of the three preferences is determined based on the average of the values 1, 1, and −1, which is determined as 0.33. This is the preference of the group of Users A through C for the image of Round 6. The preference 0.33 is added to the weights of Potatoes, Beans, Fish, and Basil.

In Round 7, represented by column 366, a seventh image is presented to Users A through C. The image is selected based on including the tags Chicken, Italian, Corn, and Cottage Cheese. The image is also selected based on including additional tags of, for example, Fish. In response, Users A through C provide a positive preference for the image displayed during Round 7, and User C provides a negative preference for the image displayed during Round 7. Again, the average of the three preferences is determined based on the average of the values 1, 1, and −1, which is determined as 0.33. This is the preference of the group of Users A through C for the image of Round 7. The preference 0.33 is added to the weights of Chicken, Italian, Corn, Cottage Cheese, and Fish.

In Round 8, represented by column 368, an eighth image is presented to User A through C. The image is selected based on including the tags Italian, Corn, and Cottage Cheese. The image is also selected based on including additional tags of, for example, Basil. In response, Users A through C provide a positive preference for the image displayed during Round 8, and User C provides a negative preference for the image displayed during Round 8. Again, the average of the three preferences is determined based on the average of the values 1, 1, and −1, which is determined as 0.33. This is the preference of the group of Users A through C for the image of Round 8. The preference 0.33 is added to the weights of Italian, Corn, Cottage Cheese, and Basil.

In one or more embodiments, the session represented by FIG. 3B can stop once one or more tags reaches a weight of, for example, 1.5. In one or more embodiments, the session represented by FIG. 3B can stop once at least three tags reaches a weight of, for example, 1.5. In the particular example of FIG. 3B, the session stops after the tags of Potatoes, Beans, and Italian reach the weight of 1.5. In which case, the process can recommend an image that includes the tags of Potatoes, Beans, and Italian.

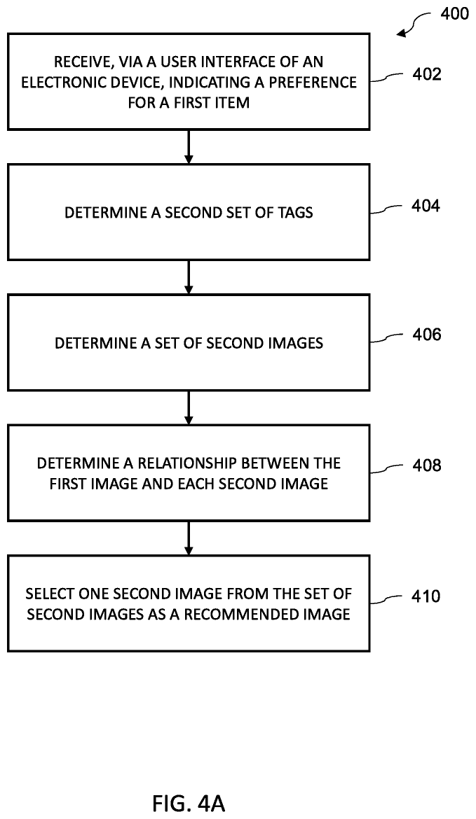

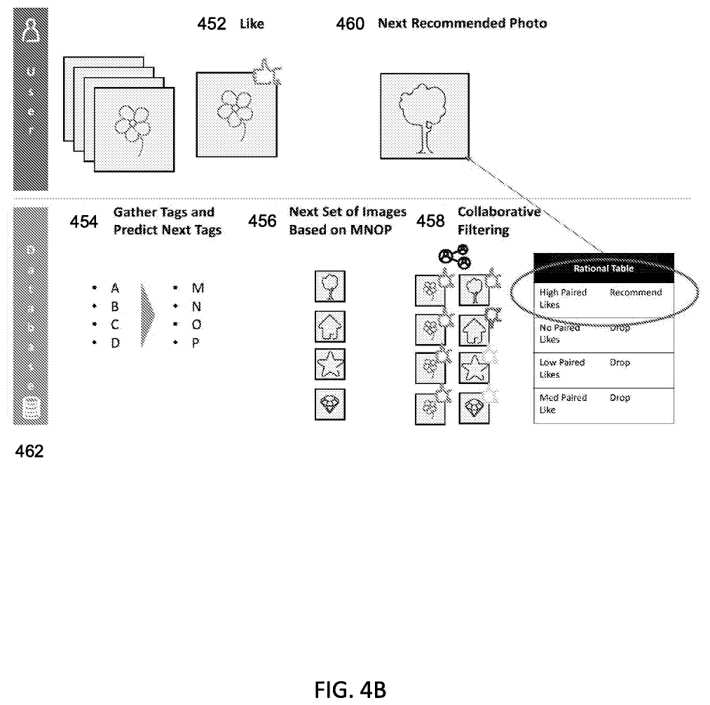

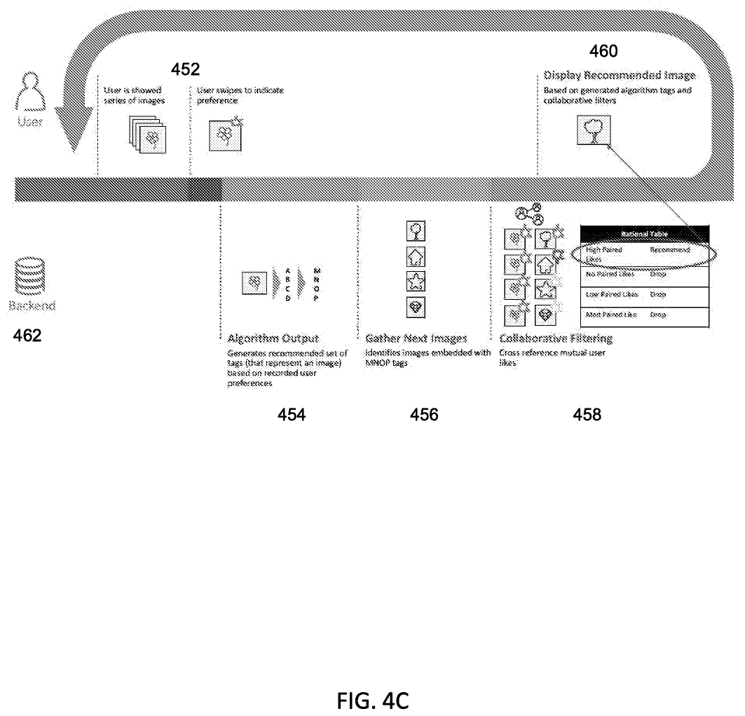

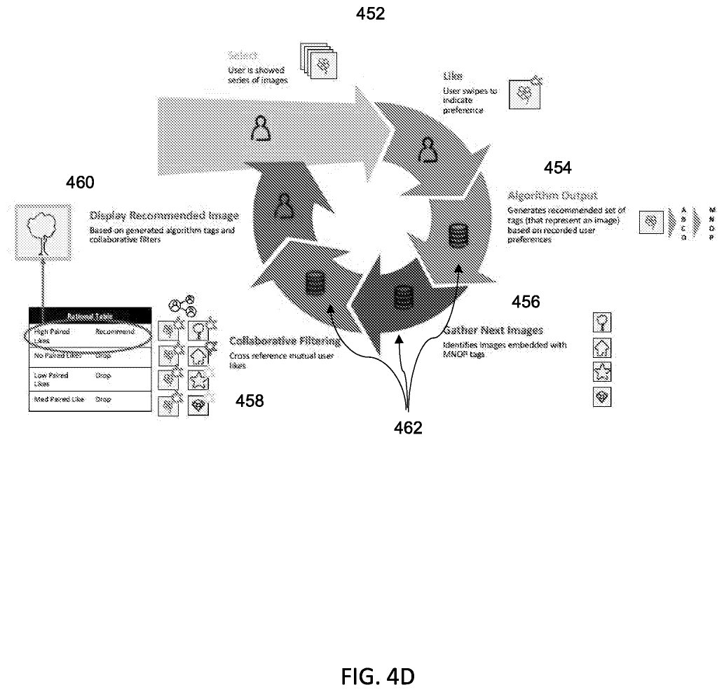

FIG. 4A is a flowchart of a computer-implemented method or algorithm 400 of collaborative filtering, using aspects of the present disclosure including the one or more computers 102a, 102b, the server 106, and the database 108. The computer-implemented method or algorithm 400 may be executed within a computer 102a, the server 106, the database 108, or across multiple platforms, such as on the computer 102a and the server 106. In regard of the latter arrangement, an application 114a executed by the computer 102a (e.g., client-side application) may perform the computer-implemented method or algorithm 400 in conjunction with an application executed on the server 106 (e.g., server-side application) according to a client-server relationship.

The computer-implemented method or algorithm 400 begins at 402 where the hardware implementing the computer-implemented method or algorithm 400 receives an input by a user, via a user interface of an electronic device, indicating a preference for a first item represented by a first image presented on a display of the electronic device, the first image being associated with a first set of tags.

FIGS. 4B-4D illustrate the step 402 at 452 by the user providing a “thumbs up” or a “like” to indicate a positive preference for the item of, for example, a flower presented on the display of a user interface of an electronic device.

The computer-implemented method or algorithm 400 continues at 404 where the hardware implementing the computer-implemented method or algorithm 400 determines a second set of tags based, at least in part, on the first item, the first set of tags, or a combination thereof.

FIGS. 4B-4D illustrate the step 404 at 454 by the computer-implemented method or algorithm, represented by the database 462, determining the next set of tags M, N, O, and P based on the prior set of tags A, B, C, and D and the preference of the user.

The computer-implemented method or algorithm 400 continues at 406 where the hardware implementing the computer-implemented method or algorithm 400 determines a set of second images associated with the second set of tags. In one or more embodiments, the second set of tags is based, at least in part, on a profile associated with the user. In one or more embodiments, the second set of tags includes at least one tag from the first set of tags, if the preference for the first item is positive. In one or more embodiments, the second set of tags includes the first set of tags in addition to one or more additional tags from a plurality of tags, if the preference for the first item is positive. In one or more embodiments, the second set of tags excludes at least one tag from the first set of tags, if the preference for the first item is negative. In one or more embodiments, the second set of tags excludes the first set of tags, if the preference for the first item is negative. In one or more embodiments, the second set of tags is randomly selected from a plurality of tags, the plurality of tags including the first set of tags. In one or more embodiments, each tag of the plurality of tags indicates an attribute of one or more images of a plurality of images, and the plurality of images include the first image, the set of second images, and one or more additional images.

FIGS. 4B-4D illustrate the step 406 at 456 by the computer-implemented method or algorithm, represented by the database 462, determining the next set of images based on the next set of tags M, N, O, and P.

The computer-implemented method or algorithm 400 continues at 408 where the hardware implementing the computer-implemented method or algorithm 400 determines a weighted relationship between the first image and each second image of the second set of images, the weighted relationship being based on preferences of a plurality of users for the first image and each second image of the second set of images. In one or more embodiments, the weighted relationship between the first image and the one second image has a highest number of shared preferences between the first image and the one second image as compared to between the first image and the each remaining second image of the set of second images. In one or more embodiments, the plurality of users is within a community with the user. In one or more embodiments, the community is a user-defined community and the plurality of users and the users joined the community. In one or more embodiments, the community is based on at least one shared trait between the plurality of users and the user. In one or more embodiments, the at least one shared trait is based on age, gender, location, common user-selected tags, etc.

FIGS. 4B-4D illustrate the step 408 at 458 by the computer-implemented method or algorithm, represented by the database 462, determining the weighted relationships between the image presented at step 452 and the next set of images determined at step 406. For example, users that provided a positive preference for the first image may have also provided a positive preference for the tree, a negative preference for the house, and neutral or negative preferences for the star and the diamond.

The computer-implemented method or algorithm 400 continues at 410 where the hardware implementing the computer-implemented method or algorithm 400 selects one second image from the set of second images as a recommended image based on the weighted relationship between the first image and the one second image relative to the weighted relationships between the first image and each remaining second image of the set of second images.

After 410, the computer-implemented method or algorithm 400 can transmit the recommended image to the electronic device of the user for presenting on the display of the electronic device. The computer-implemented method or algorithm 400 can further generate a sequence of images by repeating the receiving, the determining of the second set of tags, the determining of the set of second images, the determining of the weighted relationship, the selecting, and the transmitting, with the recommended image in place of the first image or a preceding image during a session of presenting an interest of the user.

FIGS. 4B-4D illustrate the step 410 at 460 by the computer-implemented method or algorithm, represented by the database 462, selecting one image from the next set of images to present the image to the user. The computer-implemented method or algorithm can present an iterative set of images by performing the acts 452 through 460 repeatedly during a session.

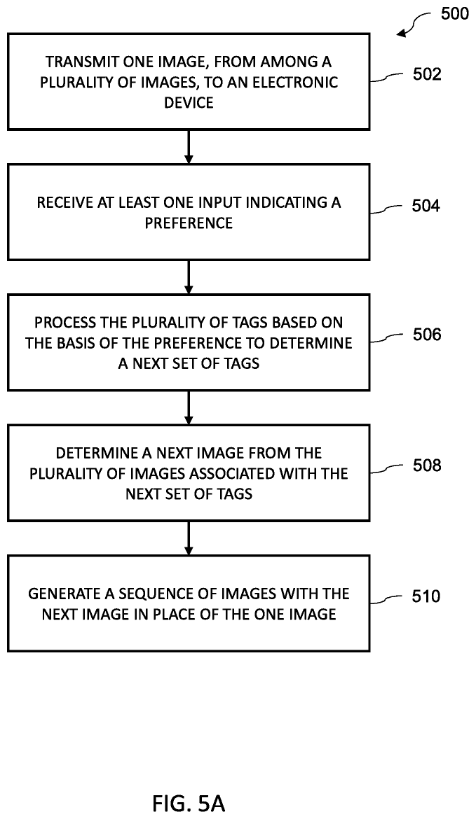

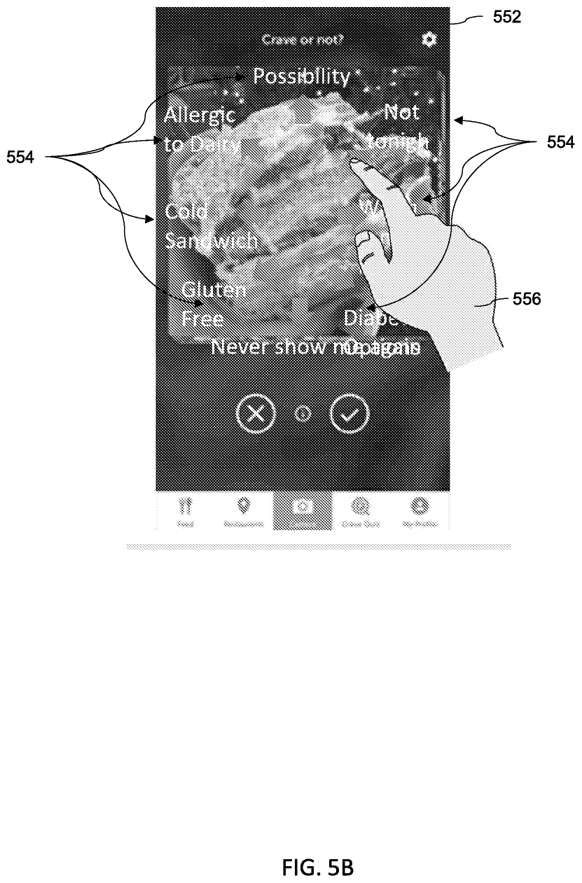

FIG. 5A is a flowchart of a computer-implemented method or algorithm 500 for providing a basis for a preference of a user, using aspects of the present disclosure including the one or more computers 102a, 102b, the server 106, and the database 108. The computer-implemented method or algorithm 500 may be executed within a computer 102a, the server 106, the database 108, or across multiple platforms, such as on the computer 102a and the server 106. In regard of the latter arrangement, an application 114a executed by the computer 102a (e.g., client-side application) may perform the computer-implemented method or algorithm 500 in conjunction with an application executed on the server 106 (e.g., server-side application) according to a client-server relationship.

The computer-implemented method or algorithm 500 begins at 502 where the hardware implementing the computer-implemented method or algorithm 500 transmits one image, from among a plurality of images, to an electronic device. The one image is associated with one or more sets of tags from a plurality of tags, each tag of the one or more sets of tags indicating attributes of the one image.

The computer-implemented method or algorithm 500 continues at 504 where the hardware implementing the computer-implemented method or algorithm 500 receives at least one input indicating a preference of the user for the one image and a basis or the “why” for the preference of the user. In one or more embodiments, the at least one input includes a first input that indicates the preference of the user for the one image and at least one second input that indicates the basis of the preference of the user. In one or more embodiments, the computer-implemented method or algorithm 500 transmits a representation of each tag of the one or more sets of tags to the electronic device. The at least one second input includes a selection by the user of at least one representation of the representations of the one or more sets of tags as the basis of the preference for the user.

FIG. 5B illustrates one example of a user interface 552 on a display of an electronic device at least partially implementing the computer-implemented method or algorithm 500. Tags 554 can be presented on the user interface 552. The user, represented by the hand 556, can provide an input that both indicates a preference, such as negative in the example of FIG. 5B, and also indicates the basis of the preference, such as “Not tonight.” In one or more embodiments, the user can swipe his or her hand from, for example, the “X” on the user interface 552 to provide the preference and continue the swipe to the tag 554 of “Not tonight” to provide the basis. In one or more alternative embodiments, the user can swipe his or her hand in two separate actions to select the preference and the basis. Further, the input associated with FIG. 5B is illustrative and not meant to be limiting; other inputs and selections can be implemented to provide the preference and the basis.

The computer-implemented method or algorithm 500 continues at 506 where the hardware implementing the computer-implemented method or algorithm 500 processes the plurality of tags based on the basis of the preference to determine a next set of tags from the plurality of tags. In one or more embodiments, the computer-implemented method or algorithm 500 excludes one or more tags associated with the basis of the preference for determining the next set of tags when the preference is negative. In one or more embodiments, the computer-implemented method or algorithm 500 excludes all tags associated with the basis of the preference for determining the next set of tags when the preference is negative. In one or more embodiments, the computer-implemented method or algorithm 500 includes one or more tags associated with the basis of the preference and from the one or more sets of tags for determining the next set of tags when the preference is positive.

The computer-implemented method or algorithm 500 continues at 508 where the hardware implementing the computer-implemented method or algorithm 500 determines a next image from the plurality of images associated with the next set of tags, the next set of tags indicating attributes of the next image.

The computer-implemented method or algorithm 500 continues at 510 where the hardware implementing the computer-implemented method or algorithm 500 generates a sequence of images by repeating the transmitting, the receiving of the first input, the processing, and the determining with the next image in place of the one image during a session of presenting an interest of the user.

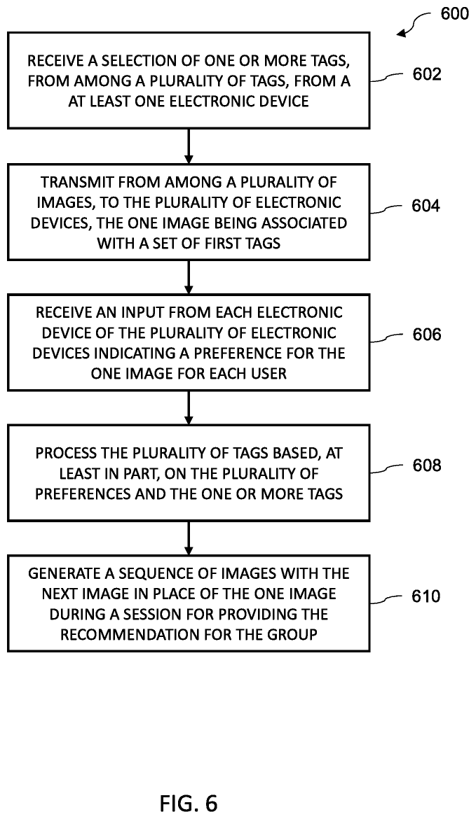

FIG. 6 is a flowchart of a computer-implemented method or algorithm 600 for providing a recommendation for a group of users, using aspects of the present disclosure including the one or more computers 102a, 102b, the server 106, and the database 108. The computer-implemented method or algorithm 600 may be executed within a computer 102a, the server 106, the database 108, or across multiple platforms, such as on the computer 102a and the server 106. In regard of the latter arrangement, an application 114a executed by the computer 102a (e.g., client-side application) may perform the computer-implemented method or algorithm 600 in conjunction with an application executed on the server 106 (e.g., server-side application) according to a client-server relationship.

The computer-implemented method or algorithm 600 begins at 602 where the hardware implementing the computer-implemented method or algorithm 600 receives, by one or more computer devices, a selection of one or more tags, from among a plurality of tags, from at least one electronic device, from among a plurality of electronic devices associated with the group of users. In one or more embodiments, the one or more tags are all included within the set of first tags. In one or more embodiments, each tag of the one or more tags corresponds to a separate user of the group of users.

The computer-implemented method or algorithm 600 continues at 604 where the hardware implementing the computer-implemented method or algorithm 600 transmits, from the one or more computer devices, one image, from among a plurality of images, to the plurality of electronic devices, the one image being associated with a set of first tags from among a plurality of tags, each tag of the set of first tags describing or characterizing attributes of the one image, and at least one tag from the one or more tags being included within the set of first tags.

The computer-implemented method or algorithm 600 continues at 606 where the hardware implementing the computer-implemented method or algorithm 600 receives, by the one or more computer devices, and from the plurality of electronic devices, an input from each electronic device of the plurality of electronic devices indicating a preference for the one image for each user of the plurality of users.

The computer-implemented method or algorithm 600 continues at 608 where the hardware implementing the computer-implemented method or algorithm 600 processes, by the one or more computer devices, the plurality of tags based, at least in part, on the plurality of preferences and the one or more tags to determine a next image from the plurality of images, the next image being different from the one image and including at least one tag from the one or more tags.

The computer-implemented method or algorithm 600 continues at 610 where the hardware implementing the computer-implemented method or algorithm 600 generates a sequence of images by repeating the transmitting, the receiving, and the processing with the next image in place of the one image during a session for providing the recommendation for the group.

While this disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the invention(s) as defined by the appended claims.

Each of these embodiments, and obvious variations thereof, is contemplated as falling within the spirit and scope of the claimed invention(s), which are set forth in the following claims. Moreover, the present concepts expressly include any and all combinations and sub-combinations of the preceding elements and aspects.

What is claimed is:

1. A computer-implemented method for providing a recommendation for a group comprising:
receiving, by one or more computer devices, an indication, from a plurality of electronic devices associated with a plurality of users, of an instance of an application executed on each electronic device of the plurality of electronic devices, the plurality of indications identifying the plurality of electronic devices as belonging to the group;
transmitting, from the one or more computer devices, one image, from among a plurality of images, to the plurality of electronic devices, the one image being associated with one or more sets of tags from among a plurality of tags, each tag of the one or more sets of tags describing or characterizing attributes of the one image;
receiving, by the one or more computer devices, and from the plurality of electronic devices, an input from each electronic device of the plurality of electronic devices indicating a preference for the one image for each user of the plurality of users;
determining, by the one or more computer devices, a group preference based on the plurality of preferences for the one image;
weighting, by the one or more computer devices, each tag of the one or more sets of tags based, at least in part, on the group preference;
processing, by the one or more computer devices, the plurality of tags based, at least in part, on the weighted tags of the one or more sets of tags, the group preference, or a combination thereof to determine a next image from the plurality of images associated with the weighted tags, the next image being different from the one image; and
generating, by one or more computer devices, a sequence of images by repeating the transmitting, the receiving, the determining, the weighting, and the processing with the next image in place of the one image and the weighted tags in place of the one or more sets of tags during a session for providing the recommendation for the group.

2. The method of claim 1, further comprising:
receiving, from one electronic device, among the plurality of electronic devices, associated with one user from the plurality of users, a request to invite a remainder of the plurality of users to form the group; and
transmitting, from the one or more computer devices, invitations to electronic devices associated with the remainder of the plurality of users to join the group,
wherein the indications from the electronic devices associated with the remainder of the plurality of users correspond to acceptances of the invitations.

3. The method of claim 1, wherein the processing further comprises:
determining, by the one or more computer devices, a next set of tags based, at least in part, on the weighted tags of the one or more sets of tags; and
determining, by the one or more computer devices, the next image from the plurality of images based, at least in part, on the next image being associated with each tag of the next set of tags.

4. The method of claim 3, wherein the next set of tags include highest weighted tags from the plurality of tags and one or more additional tags.

5. The method of claim 1, wherein the weighting further comprises:
incrementing, by the one or more computer devices, a weight of each tag of the one or more sets of tags a positive value based, at least in part, on the group preference being positive; and
decrementing, by the one or more computer devices, the weight of each tag of the one or more sets of tags a negative value based, at least in part, on the group preference being negative.

6. The method of claim 1, wherein each preference of the one image is assigned separate numerical values based on a positive preference and a negative preference, and the group preference is an average of the numerical values.

7. The method of claim 6, wherein the numerical value for the positive preference is 1 and the numerical value for the negative preference is −1.

8. The method of claim 1, further comprising:
determining, by the one or more computer devices, that a weighting of at least one tag from the plurality of tags has attained a threshold value;
determining, by the one or more computer devices, at least one image from the plurality of images that is associated with the at least one tag; and
providing, by the one or more computer devices, the at least one image as the recommendation to the group.

9. One or more computer-readable, non-transitory, storage media encoding machine-readable instructions that, when executed by one or more computers, cause operations to be carried out, the operations comprising:
receiving, by one or more computer devices, an indication, from a plurality of electronic devices associated with a plurality of users, of an instance of an application executed on each electronic device of the plurality of electronic devices, the plurality of indications identifying the plurality of electronic devices as belonging to the group;
transmitting, from the one or more computer devices, one image, from among a plurality of images, to the plurality of electronic devices, the one image being associated with one or more sets of tags from among a plurality of tags, each tag of the one or more sets of tags describing or characterizing attributes of the one image;
receiving, by the one or more computer devices, and from the plurality of electronic devices, an input from each electronic device of the plurality of electronic devices indicating a preference for the one image for each user of the plurality of users;
determining, by the one or more computer devices, a group preference based on the plurality of preferences for the one image;
weighting, by the one or more computer devices, each tag of the one or more sets of tags based, at least in part, on the group preference;
processing, by the one or more computer devices, the plurality of tags based, at least in part, on the weighted tags of the one or more sets of tags, the group preference, or a combination thereof to determine a next image from the plurality of images associated with the weighted tags, the next image being different from the one image; and
generating, by one or more computer devices, a sequence of images by repeating the transmitting, the receiving, the determining, the weighting, and the processing with the next image in place of the one image and the weighted tags in place of the one or more sets of tags during a session for providing the recommendation for the group.

10. The one or more computer-readable, non-transitory, storage media encoding machine-readable instructions of claim 9 that, when executed by one or more computers, cause operations to be carried out, the operations further comprising:
receiving, from one electronic device, among the plurality of electronic devices, associated with one user from the plurality of users, a request to invite a remainder of the plurality of users to form the group; and
transmitting, from the one or more computer devices, invitations to electronic devices associated with the remainder of the plurality of users to join the group,
wherein the indications from the electronic devices associated with the remainder of the plurality of users correspond to acceptances of the invitations.

11. The one or more computer-readable, non-transitory, storage media encoding machine-readable instructions of claim 9, wherein the processing further comprises:
determining, by the one or more computer devices, a next set of tags based, at least in part, on the weighted tags of the one or more sets of tags; and
determining, by the one or more computer devices, the next image from the plurality of images based, at least in part, on the next image being associated with each tag of the next set of tags.

12. The one or more computer-readable, non-transitory, storage media encoding machine-readable instructions of claim 11, wherein the next set of tags include highest weighted tags from the plurality of tags and one or more additional tags.

13. The one or more computer-readable, non-transitory, storage media encoding machine-readable instructions of claim 9, wherein the weighting further comprises:
incrementing, by one or more computer devices, a weight of each tag of the one or more sets of tags a positive value based, at least in part, on the group preference being positive; and
decrementing, by one or more computer devices, the weight of each tag of the one or more sets of tags a negative value based, at least in part, on the group preference being negative.

14. The one or more computer-readable, non-transitory, storage media encoding machine-readable instructions of claim 9, wherein each preference of the one image is assigned separate numerical values based on a positive preference and a negative preference, and the group preference is an average of the numerical values.

15. The one or more computer-readable, non-transitory, storage media encoding machine-readable instructions of claim 14, wherein the numerical value for the positive preference is 1 and the numerical value for the negative preference is −1.

16. The one or more computer-readable, non-transitory, storage media encoding machine-readable instructions of claim 9 that, when executed by one or more computers, cause operations to be carried out, the operations further comprising:
determining, by the one or more computer devices, that a weighting of at least one tag from the plurality of tags has attained a threshold value;
determining, by the one or more computer devices, at least one image from the plurality of images that is associated with the at least one tag; and
providing, by the one or more computer devices, the at least one image as the recommendation to the group.

17. A computer-implemented method of collaborative filtering comprising:
receiving, by one or more computer devices, an input by a user, via a user interface of an electronic device, indicating a preference for a first item represented by a first image presented on a display of the electronic device, the first image being associated with a first set of tags;
determining, by the one or more computer devices, a second set of tags based, at least in part, on the first item, the first set of tags, or a combination thereof;
determining, by the one or more computer devices, a set of second images associated with the second set of tags;
determining, by the one or more computer devices, a weighted relationship between the first image and each second image of the second set of images, the weighted relationship being based on preferences of a plurality of users for the first image and each second image of the second set of images; and
selecting, by the one or more computer devices, one second image from the set of second images as a recommended image based on the weighted relationship between the first image and the one second image relative to the weighted relationships between the first image and each remaining second image of the set of second images.

18. The method of claim 17, further comprising:
transmitting, by the one or more computer devices, the recommended image to the electronic device of the user for presenting on the display of the electronic device; and
generating, by the one or more computer devices, a sequence of images by repeating the receiving, the determining of the second set of tags, the determining of the set of second images, the determining of the weighted relationship, the selecting, and the transmitting, with the recommended image in place of the first image or a preceding image during a session of presenting an interest of the user.

19. The method of claim 17, wherein the weighted relationship between the first image and the one second image has a highest number of shared preferences between the first image and the one second image as compared to between the first image and the each remaining second image of the set of second images.

20. The method of claim 17, wherein the second set of tags is based, at least in part, on a profile associated with the user.

21. The method of claim 17, wherein the second set of tags includes at least one tag from the first set of tags, if the preference for the first item is positive.

22. The method of claim 21, wherein the second set of tags includes the first set of tags in addition to one or more additional tags from a plurality of tags, if the preference for the first item is positive.

23. The method of claim 17, wherein the second set of tags excludes at least one tag from the first set of tags, if the preference for the first item is negative.

24. The method of claim 17, wherein the second set of tags excludes the first set of tags, if the preference for the first item is negative.

25. The method of claim 17, wherein the second set of tags is randomly selected from a plurality of tags, the plurality of tags including the first set of tags.

26. The method of claim 17, wherein each tag of the plurality of tags indicates an attribute of one or more images of a plurality of images, and the plurality of images include the first image, the set of second images, and one or more additional images.

27. The method of claim 17, wherein the plurality of users is within a community with the user.

28. The method of claim 27, wherein the community is a user-defined community and the plurality of users and the users joined the community.

29. The method of claim 27, wherein the community is based on at least one shared trait between the plurality of users and the user.

30. The method of claim 29, wherein the at least one shared trait is based on age, gender, location, common user-selected tags.

31. One or more computer-readable, non-transitory, storage media encoding machine-readable instructions that, when executed by one or more computers, cause operations to be carried out, the operations comprising:
receiving, by one or more computer devices, an input by a user, via a user interface of an electronic device, indicating a preference for a first item represented by a first image presented on a display of the electronic device, the first image being associated with a first set of tags;
determining, by the one or more computer devices, a second set of tags based, at least in part, on the first item, the first set of tags, or a combination thereof;
determining, by the one or more computer devices, a set of second images associated with the second set of tags;
determining, by the one or more computer devices, a weighted relationship between the first image and each second image of the second set of images, the weighted relationship being based on preferences of a plurality of users for the first image and each second image of the second set of images; and
selecting, by the one or more computer devices, one second image from the set of second images as a recommended image based on the weighted relationship between the first image and the one second image relative to the weighted relationships between the first image and each remaining second image of the set of second images.

32. One or more computer-readable, non-transitory, storage media encoding machine-readable instructions of claim 31 that, when executed by one or more computers, cause operations to be carried out, the operations further comprising:
transmitting, by the one or more computer devices, the recommended image to the electronic device of the user for presenting on the display of the electronic device; and
generating, by one or more computer devices, a sequence of images by repeating the receiving, the determining of the second set of tags, the determining of the set of second images, the determining of the weighted relationship, the selecting, and the transmitting, with the recommended image in place of the first image or a preceding image during a session of presenting an interest of the user.

33. One or more computer-readable, non-transitory, storage media encoding machine-readable instructions of claim 31, wherein the weighted relationship between the first image and the one second image has a highest number of shared preferences between the first image and the one second image as compared to between the first image and the each remaining second image of the set of second images.

34. One or more computer-readable, non-transitory, storage media encoding machine-readable instructions of claim 31, wherein the second set of tags is based, at least in part, on a profile associated with the user.

35. One or more computer-readable, non-transitory, storage media encoding machine-readable instructions of claim 31, wherein the second set of tags includes at least one tag from the first set of tags, if the preference for the first item is positive.

36. One or more computer-readable, non-transitory, storage media encoding machine-readable instructions of claim 35, wherein the second set of tags includes the first set of tags in addition to one or more additional tags from a plurality of tags, if the preference for the first item is positive.

37. One or more computer-readable, non-transitory, storage media encoding machine-readable instructions of claim 31, wherein the second set of tags excludes at least one tag from the first set of tags, if the preference for the first item is negative.

38. One or more computer-readable, non-transitory, storage media encoding machine-readable instructions of claim 31, wherein the second set of tags excludes the first set of tags, if the preference for the first item is negative.

39. One or more computer-readable, non-transitory, storage media encoding machine-readable instructions of claim 31, wherein the second set of tags is randomly selected from a plurality of tags, the plurality of tags including the first set of tags.

40. One or more computer-readable, non-transitory, storage media encoding machine-readable instructions of claim 31, wherein each tag of the plurality of tags indicates an attribute of one or more images of a plurality of images, and the plurality of images include the first image, the set of second images, and one or more additional images.

41. One or more computer-readable, non-transitory, storage media encoding machine-readable instructions of claim 31, wherein the plurality of users is within a community with the user.

42. One or more computer-readable, non-transitory, storage media encoding machine-readable instructions of claim 41, wherein the community is a user-defined community and the plurality of users and the users joined the community.

43. One or more computer-readable, non-transitory, storage media encoding machine-readable instructions of claim 41, wherein the community is based on at least one shared trait between the plurality of users and the user.

44. One or more computer-readable, non-transitory, storage media encoding machine-readable instructions of claim 43, wherein the at least one shared trait is based on age, gender, location, common user-selected tags.

45. A computer-implemented method for providing a basis for a preference of a user comprising:
transmitting, from one or more computer devices, one image, from among a plurality of images, to an electronic device, the one image being associated with one or more sets of tags from a plurality of tags, each tag of the one or more sets of tags indicating attributes of the one image;
receiving, from the electronic device, at least one input indicating a preference of the user for the one image and a basis of the preference of the user;
processing, by the one or more computer devices, the plurality of tags based on the basis of the preference to determine a next set of tags from the plurality of tags;
determining, by the one or more computer devices, a next image from the plurality of images associated with the next set of tags, the next set of tags indicating attributes of the next image; and
generating, by one or more computer devices, a sequence of images by repeating the transmitting, the receiving of the at least one input, the processing, and the determining with the next image in place of the one image and the next set of tags in place of the one or more sets of tags during a session of presenting an interest of the user.

46. The method of claim 45, wherein the at least one input includes a first input that indicates the preference of the user for the one image, and wherein the at least one input includes at least one second input that indicates the basis of the preference of the user.

47. The method of claim 46, further comprising:
transmitting, by the one or more computer devices, a representation of each tag of the one or more sets of tags to the electronic device,
wherein the at least one second input includes a selection by the user of at least one representation of the representations of the one or more sets of tags as the basis of the preference for the user.

48. The method of claim 45, wherein the processing of the plurality of tags further comprises:
excluding, by the one or more computers, one or more tags associated with the basis of the preference for determining the next set of tags when the preference is negative.

49. The method of claim 48, wherein the processing of the plurality of tags further comprises:
excluding, by the one or more computers, all tags associated with the basis of the preference for determining the next set of tags when the preference is negative.

50. The method of claim 45, wherein the processing of the plurality of tags further comprises:
including, by the one or more computers, one or more tags associated with the basis of the preference and from the one or more sets of tags for determining the next set of tags when the preference is positive.

51. One or more computer-readable, non-transitory, storage media encoding machine-readable instructions that, when executed by one or more computers, cause operations to be carried out, the operations comprising:
transmitting, from one or more computer devices, one image, from among a plurality of images, to an electronic device, the one image being associated with one or more sets of tags from a plurality of tags, each tag of the one or more sets of tags indicating attributes of the one image;
receiving, from the electronic device, at least one input indicating a preference of the user for the one image and a basis of the preference of the user;
processing, by the one or more computer devices, the plurality of tags based on the basis of the preference to determine a next set of tags from the plurality of tags;
determining, by the one or more computer devices, a next image from the plurality of images associated with the next set of tags, the next set of tags indicating attributes of the next image; and
generating, by one or more computer devices, a sequence of images by repeating the transmitting, the receiving of the at least one input, the processing, and the determining with the next image in place of the one image and the next set of tags in place of the one or more sets of tags during a session of presenting an interest of the user.

52. One or more computer-readable, non-transitory, storage media encoding machine-readable instructions of claim 51, wherein the at least one input includes a first input that indicates the preference of the user for the one image, and wherein the at least one input includes at least one second input that indicates the basis of the preference of the user.

53. One or more computer-readable, non-transitory, storage media encoding machine-readable instructions of claim 51 that, when executed by one or more computers, cause operations to be carried out, the operations further comprising:
transmitting, by the one or more computer devices, a representation of each tag of the one or more sets of tags to the electronic device,
wherein the at least one second input includes a selection by the user of at least one representation of the representations of the one or more sets of tags as the basis of the preference for the user.

54. One or more computer-readable, non-transitory, storage media encoding machine-readable instructions of claim 51, wherein the processing of the plurality of tags further comprises:
excluding, by the one or more computers, one or more tags associated with the basis of the preference for determining the next set of tags when the preference is negative.

55. One or more computer-readable, non-transitory, storage media encoding machine-readable instructions of claim 54, wherein the processing of the plurality of tags further comprises:
excluding, by the one or more computers, all tags associated with the basis of the preference for determining the next set of tags when the preference is negative.

56. One or more computer-readable, non-transitory, storage media encoding machine-readable instructions of 51, wherein the processing of the plurality of tags further comprises:
including, by the one or more computers, one or more tags associated with the basis of the preference and from the one or more sets of tags for determining the next set of tags when the preference is positive.

57. A computer-implemented method for providing a recommendation for a group of users comprising:
receiving, by one or more computer devices, a selection of one or more tags, from among a plurality of tags, from at least one electronic device, from among a plurality of electronic devices associated with the group of users;
transmitting, from the one or more computer devices, one image, from among a plurality of images, to the plurality of electronic devices, the one image being associated with a set of first tags from among a plurality of tags, each tag of the set of first tags describing or characterizing attributes of the one image, and at least one tag from the one or more tags being included within the set of first tags;
receiving, by the one or more computer devices, and from the plurality of electronic devices, an input from each electronic device of the plurality of electronic devices indicating a preference for the one image for each user of the plurality of users;
processing, by the one or more computer devices, the plurality of tags based, at least in part, on the plurality of preferences and the one or more tags to determine a next image from the plurality of images, the next image being different from the one image and including at least one tag from the one or more tags; and
generating, by one or more computer devices, a sequence of images by repeating the transmitting, the receiving, and the processing with the next image in place of the one image during a session for providing the recommendation for the group.

58. The method of claim 57, wherein the one or more tags are all included within the set of first tags.

59. The method of claim 57, wherein each tag of the one or more tags corresponds to a separate user of the group of users.

60. One or more computer-readable, non-transitory, storage media encoding machine-readable instructions that, when executed by one or more computers, cause operations to be carried out, the operations comprising:
receiving, by one or more computer devices, a selection of one or more tags, from among a plurality of tags, from at least one electronic device, from among a plurality of electronic devices associated with the group of users;
transmitting, from the one or more computer devices, one image, from among a plurality of images, to the plurality of electronic devices, the one image being associated with a set of first tags from among a plurality of tags, each tag of the set of first tags describing or characterizing attributes of the one image, and at least one tag from the one or more tags being included within the set of first tags;
receiving, by the one or more computer devices, and from the plurality of electronic devices, an input from each electronic device of the plurality of electronic devices indicating a preference for the one image for each user of the plurality of users; processing, by the one or more computer devices, the plurality of tags based, at least in part, on the plurality of preferences and the one or more tags to determine a next image from the plurality of images, the next image being different from the one image and including at least one tag from the one or more tags; and
generating, by one or more computer devices, a sequence of images by repeating the transmitting, the receiving, and the processing with the next image in place of the one image during a session for providing the recommendation for the group.

61. One or more computer-readable, non-transitory, storage media encoding machine-readable instructions of claim 57, wherein the one or more tags are all included within the set of first tags.

62. One or more computer-readable, non-transitory, storage media encoding machine-readable instructions of claim 57, wherein each tag of the one or more tags corresponds to a separate user of the group of users.
